(19) United States
(12) Patent Application Publication
(10) Pub. No.: US 2022/0206744 A1
(43) Pub. Date: Jun. 30, 2022

(54) CONVERSION APPARATUS, CONVERSION METHOD AND PROGRAM

(71) Applicant: NIPPON TELEGRAPH AND TELEPHONE CORPORATION, Tokyo (JP)

(72) Inventor: Rika MOCHIZUKI, Tokyo (JP)

(73) Assignee: NIPPON TELEGRAPH AND TELEPHONE CORPORATION, Tokyo (JP)

(21) Appl. No.: 17/611,494

(22) PCT Filed: May 17, 2019
(86) PCT No.: PCT/JP2019/019781

§ 371 Date: Nov. 15, 2021

(51) Int. Cl. G06F 5/00; G06K 9/00

(52) U.S. Cl. CPC G06F 5/00; G06K 9/00536

(57) ABSTRACT

A conversion apparatus includes: a determination unit configured to, using a numeric value of an amount of a given type as input, determine a conversion method to be applied to the numeric value among multiple conversion methods based on the type of the amount and the size of the numeric value; a conversion unit configured to convert the numeric value into a relative value obtained based on a predetermined reference, using the conversion method determined by the determination unit; and an output unit configured to output a result of applying the value to a predetermined template, and thereby the conversion apparatus generates an expression that is easy to understand.

### TECHNICAL FIELD

The present invention relates to a conversion apparatus, a conversion method, and a program.

### BACKGROUND ART

Numeric expressions that can be understood by experts but are not very common sometimes appear in the news, textbooks, and the like. Examples of such expressions can include expressions of distance using units that Japanese people are not familiar with, such as 7000 miles, expressions of size that one cannot get a sense of by viewing, such as the size of a star or the size of a microorganism, and expressions of target objects that do not actually exist, such as fictional buildings and the like that appear in films, novels, and the like. It is difficult to convey the farness of such distances, the largeness/smallness of such sizes, and the sense of scale of such fictional objects. A technique has been proposed which presents such phenomena, which are unfamiliar and difficult to imagine, in a manner that is easy to understand through comparison with known phenomena.

For example, NPL 1 has proposed a method in which information of an unfamiliar country is illustrated side-by-side with information of one's own country, thereby promoting understanding of the sense of degree of the information.

Also, NPL 2 has proposed a method in which understanding of an unknown object is promoted by, based on a life log of a user, presenting an object that is similar and is known to the user.

### CITATION LIST

### Non-Patent Literature

[NPL 1] R. Shimasaki, T. Uetake, “Proposal of a Country Information Comprehension System Using Infographics”, The 77th National Convention of ISPJ, 5ZA-03, pp. 321-322, 2015.
[NPL 2] R. Mochizuki, T. Watanabe, D. Namikawa, K. Tanaka, T. Yamada, “Evaluation about personalized metaphor agent system”, Proceedings of Forum on Information Technology 12(4), pp. 137-144, 2013.

### SUMMARY OF THE INVENTION

### Technical Problem

NPL 1 proposes a system for automatically illustrating information such as the population of a country one is visiting for the first time, side-by-side with information of one's own country, and proposes a method for promoting understanding. However, although units that are used in common in all countries for population, area, and the like can be converted, it is difficult to show a comparison in the case of information that is not present depending on the country, such as a volcano.

Also, NPL 2 promotes understanding of an unknown object by presenting an object that is similar and is known to user by accumulating and referring to life logs of individuals. However, since this is premised on the life logs being acquired and the scheme of NPL 2 is a scheme that is specialized for an individual, expressions that are easy for everyone to understand cannot be generated.

The present invention was made in view of the above-described points and aims to generate expressions that are easy to understand.

### Means for Solving the Problem

In view of this, in order to solve the above-described problems, a conversion apparatus includes: a determination unit configured to, using a numeric value of an amount of a given type as input, determine a conversion method to be applied to the numeric value among a plurality of conversion methods based on the type of the amount and the size of the numeric value; a conversion unit configured to convert the numeric value into a relative value obtained based on a predetermined reference, using the conversion method determined by the determination unit; and an output unit configured to output a result of applying the value to a predetermined template.

### Effects of the Invention

It is possible to generate expressions that are easy to understand.

### BRIEF DESCRIPTION OF DRAWINGS

FIG. 1 is a diagram showing an example of a hardware configuration of a conversion apparatus 10 according to an embodiment of the present invention.

FIG. 2 is a diagram showing an example of a functional configuration of a conversion apparatus 10 according to an embodiment of the present invention.

FIG. 3 is a flowchart for illustrating an example of a processing procedure executed by the conversion apparatus 10.

FIG. 4 is a diagram showing an example of a configuration of an amount information DB 121.

FIG. 5 is a diagram showing an example of an input screen.

FIG. 6 is a diagram showing an example of a configuration of a conversion reference DB 122.

FIG. 7 is a diagram showing an example of conversion using an action time.

FIG. 8 is a diagram showing an example of conversion using perspective conversion in a case where a numeric value of weight (target object) is difficult to convey due to being too large.

FIG. 9 is a diagram showing an example of conversion using perspective conversion in a case where a numeric value of weight (target object) is difficult to convey due to being too small.

FIG. 10 is a diagram showing an example of conversion using perspective conversion in a case where a numeric value of weight (target object) is difficult to convey due to being too small.

FIG. 11 is a diagram showing an example of conversion through projection.

FIG. 12 is a diagram for illustrating an example of a reference for determining whether or not to use “multiple” as a “conversion method”.

FIG. 13 is a diagram showing an example of a configuration of a conversion method DB 123.

FIG. 14 is a diagram showing an example of a configuration of a human information DB 124.

FIG. 15 is a diagram showing an example of a configuration of a general reference DB 125.

FIG. 16 is a diagram showing an example of a configuration of a presented expression DB 126.

FIG. 17 is a diagram for illustrating conversion processing for projection.

### DESCRIPTION OF EMBODIMENTS

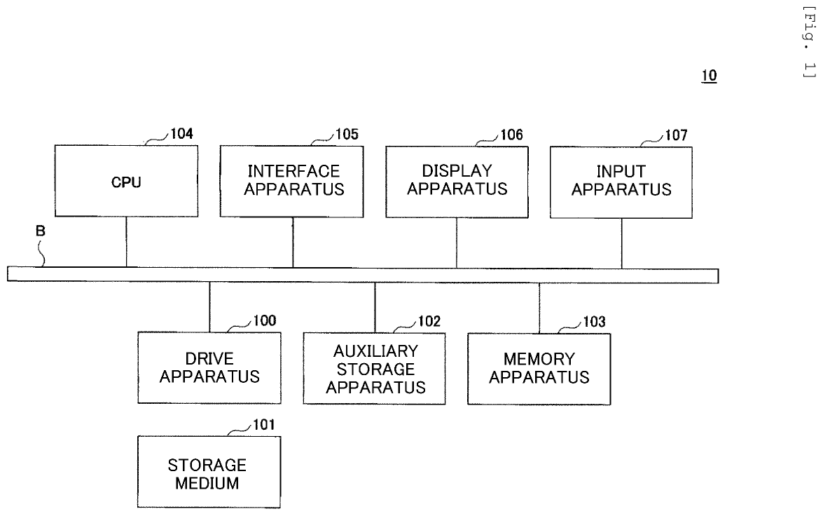

Hereinafter, embodiments of the present invention will be described with reference to the drawings. FIG. 1 is a diagram showing an example of a hardware configuration of a conversion apparatus 10 according to an embodiment of the present invention. The conversion apparatus 10 according to FIG. 1 includes a drive apparatus 100, an auxiliary storage apparatus 102, a memory apparatus 103, a CPU 104, an interface apparatus 105, a display apparatus 106, an input apparatus 107, and the like, which are connected to each other by a bus B.

A program for realizing the processing performed by the conversion apparatus 10 is provided by a storage medium 101 such as a CD-ROM. When the storage medium 101 storing the program is set in the drive apparatus 100, the program is installed in the auxiliary storage apparatus 102 from the storage medium 101 via the drive apparatus 100. However, the installation of the program does not necessarily need to be performed by the storage medium 101, and it is also possible to download the program using another computer via a network. The auxiliary storage apparatus 102 stores the installed program and stores the needed files, data, and the like.

If there is a startup instruction for the program, the memory apparatus 103 stores the program by reading out the program from the auxiliary storage apparatus 102. The CPU 104 realizes the functions of the conversion apparatus 10 in accordance with the program stored in the memory apparatus 103. The interface apparatus 105 is used as an interface for connecting to the network. The display apparatus 106 displays a GUI (Graphical User Interface) provided by the program. The input apparatus 107 is constituted by a keyboard, a mouse, or the like, and is used to input various operation instructions.

Note that the conversion apparatus 10 may also be a terminal used directly by a user (a PC, a smartphone, a tablet terminal, etc.), and may also be a computer (a server, a cloud, etc.) that is connected via a network to a terminal used directly by the user. In the latter case, the conversion apparatus need not include the display apparatus 106 and the input apparatus 107.

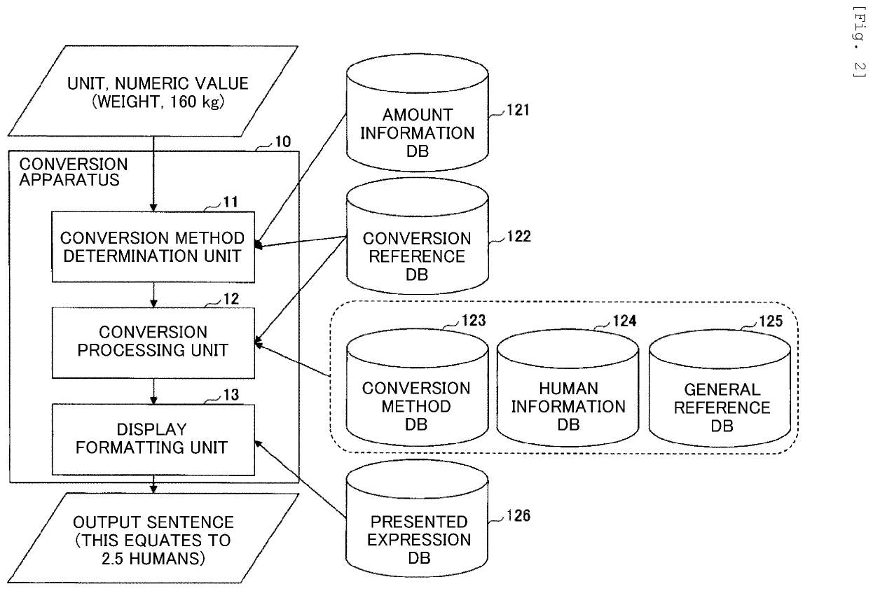

FIG. 2 is a diagram showing an example of a functional configuration of the conversion apparatus 10 according to an embodiment of the present invention. In FIG. 2, the conversion apparatus 10 includes a conversion method determination unit 11, a conversion processing unit 12, a display formatting unit 13, and the like. These units are realized through processing that one or more programs installed in the conversion apparatus 10 cause the CPU 104 to execute. The conversion apparatus 10 also uses databases (storage units) such as an amount information DB 121, a conversion reference DB 122, a conversion method DB 123, a human information DB 124, a general reference DB 125, and a presented expression DB 126. These databases can be realized using, for example, a storage apparatus or the like that can be connected to the auxiliary storage apparatus 102 or the conversion apparatus 10 via the network. Note that these databases are created in advance by, for example, a service provider.

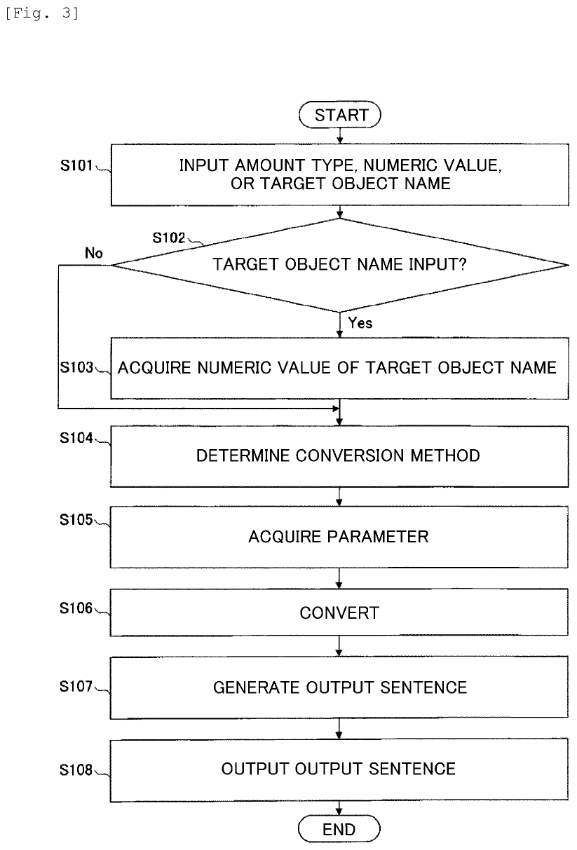

Hereinafter, a processing procedure executed by the conversion apparatus 10 will be described. FIG. 3 is a flowchart for illustrating an example of a processing procedure executed by the conversion apparatus 10.

In step S101, the conversion method determination unit 11 accepts input of the input information such as the type of amount (hereinafter referred to as “amount type”), a numeric value, a target object name, or the like. The amount type is information indicating the type of the amount (weight, length, etc.) by which to express the numeric value whose degree the user wishes to know. The numeric value is a numeric value whose degree the user wishes to know. The target object name is the name of a target object whose degree the user wishes to know. Note that input of the numeric value and the target object name is optional. Here, the amount type and the like that can be input are stored in the amount information DB 121.

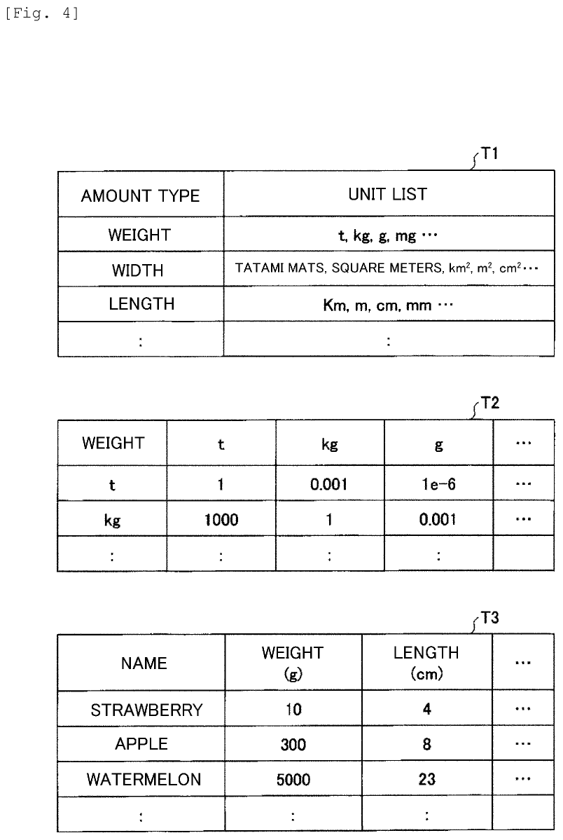

FIG. 4 is a diagram showing an example of a configuration of the amount information DB 121. As shown in FIG. 4, a table T1 including a list of units relating to the amount type for each amount type that can be input, a table T2 including a list of conversion values of the units for each amount type (note that in FIG. 4, only conversion values of units relating to weight are illustrated), a table T3 including a list of target object names that can be input instead of directly inputting a numeric value and numeric values corresponding to the target object names (any amount type and a value of a unit) are stored in the amount information DB 121. Although the table T3 is prepared in order to read out a numeric value of an amount of an input target object name in the case where a user indirectly inputs a numeric value using a target object name instead of a numeric value, the table T3 is not needed in the case where the user inputting a numeric value is set as a prerequisite. As for the method of creating the amount information DB 121, the amount information DB 121 may also be created using a method such as a service provider creating it completely though manual input while referring to a dictionary or the like, or designating a server, a Web site, or the like that is a specific citation source and using a specification in which the information of the citation source is automatically reflected when updated.

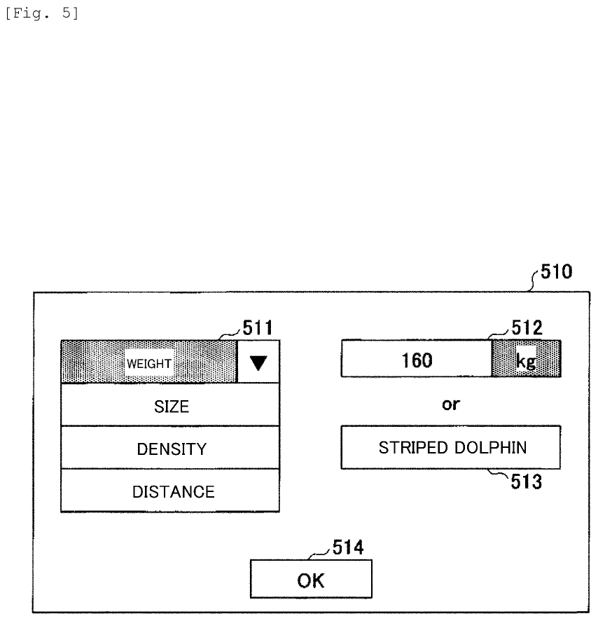

The input information in step S101 may also be input via, for example, an input screen shown in FIG. 5. FIG. 5 is a diagram showing an example of an input screen. In FIG. 5, the input screen 510 includes a list box 511, a text box 512, a text box 513, an OK button 514, and the like.

The list box 511 includes a list of amount types stored in the table T1 as options. The user selects the amount type using the list box 511. Hereinafter, the selected amount type will be referred to as “target amount type”. Note that a combo box may also be used instead of the list box 511. In this case, when the user performs character input in the text box of the combo box, selection candidates for the amount type may also be displayed through prediction conversion performed based on a portion of the input character string.

The text box 512 is a region for receiving input of a numeric value. Note that as shown in FIG. 5, one representative unit (“kg” in the drawing) in the list of units of the selected amount type may also be displayed at the right end of the text box 512 according to the selection of the amount type of the list box 511. In this case, the user need only input the numeric value in the units. Alternatively, similarly to the amount type, the units may also be selectable in the list box or the like. Hereinafter, the input numeric value will be referred to as “input value”.

The text box 513 is a region for receiving input of a target object name instead of the numeric value. That is, if the numeric value is not input to the text box 512, the target object name is input to the text box 513. Note that although an example is shown in FIG. 5 in which values have been input to both the text box 512 and the text box 513, in actuality, the input information input to the input screen 510 is “amount type, numeric value”, or “amount type, target object name”, such as “weight, 160 kg”, “weight, striped dolphin”, or the like.

Next, the conversion method determination unit 11 determines whether or not a target object name has been input instead of an input value as the input information (S102). If an input value is included (No in S102), the processing advances to step S104. If a target object name is included (Yes in S102), the conversion method determination unit 11 acquires the numeric value corresponding to the target amount type out of the group of numeric values stored in the table T3 with respect to the target object name (S103), and the processing advances to step S104. Hereinafter, the acquired numeric value will be referred to as “input value”.

That is, it is sufficient that the amount type and the numeric value are obtained as the input amount. In the example of FIG. 5, it is sufficient that “weight, 160 kg” is ultimately obtained.

In step S104, the conversion method determination unit 11 refers to the conversion reference DB 122 to determine the conversion method to be applied to the input value for the target amount type.

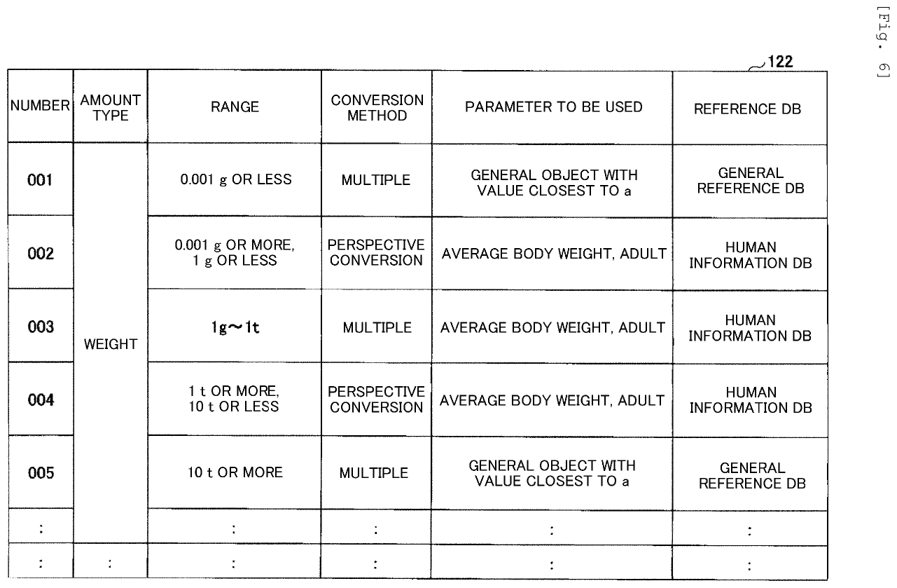

FIG. 6 is a diagram showing an example of a configuration of the conversion reference DB 122. As shown in FIG. 6, for each “range” of values of an amount type, a “number”, a “conversion method” corresponding to the range, a “parameter to be used”, a “reference DB”, and the like are stored in advance in the conversion reference DB 122.

“Number” is a number for identifying a record of the conversion reference DB 122. “Conversion method” indicates the type of the method for converting the numeric value. In the present embodiment, “multiple” and “human measure” are included in the “conversion method”. “Human measure” refers to a method of relatively replacing a magnitude relationship using a human as a reference, and “action time”, “perspective conversion”, and “projection” are included as methods that can be specifically designated as the “conversion method”. Also, “multiple” includes a method of performing expression using a multiple of a body part of a human, and a method of performing expression using a multiple of a common item. These conversion methods will be described in detail later. Note that a common item refers to an item other than a body or body part of a human.

“Parameter to be used” indicates the type of parameter to be used when performing conversion using the method indicated by “conversion method”. The “parameter to be used” is set in advance according to the amount type, such as an average body weight in the case of weight, body length in the case of height, or the like. The “reference DB” indicates the database (general reference DB 125 or human information DB 124) that is the reference location for the “parameter to be used”.

During creation (registration) of the conversion reference DB 122, the “conversion method” may also be determined with respect to each “range” using, as a reference, whether or not an expression using a multiple of a body part of a human will be understandable. For example, since it is possible to imagine a weight corresponding to that of 10 humans, it is sufficient that “multiple” is set as the “conversion method” for such a range.

On the other hand, when it comes to a weight corresponding to that of 100,000 humans, even if conversion is performed, this value will be too high and will be difficult to imagine, and thus it is desirable that description is given using an expression other than “multiple”. In this case, it is preferable that “human measure” (“action time”, “perspective conversion”, or “projection”), which is a method of relatively replacing the magnitude relationship using a human as a reference, is set as the “conversion method”.

“Action time” refers to a method of converting a numeric value into a required amount of time obtained based on the speed of a bodily action of a human (i.e., a method of likening a numeric value to a required amount of time obtained based on the speed of a bodily action of a human).

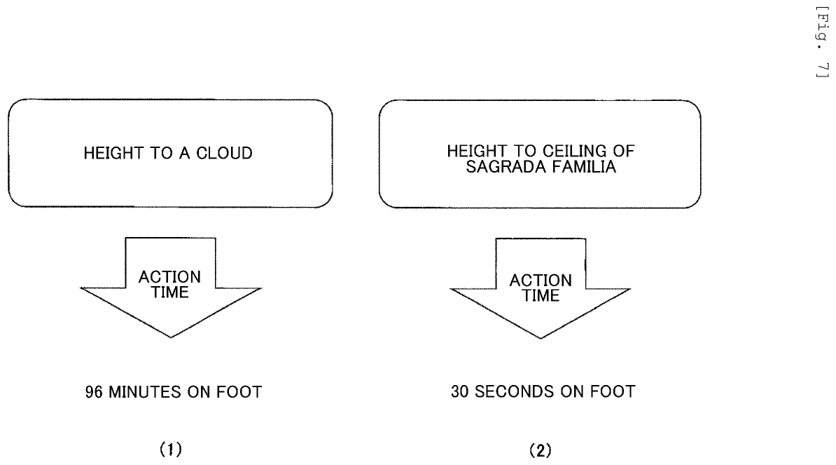

FIG. 7 is a diagram showing an example of conversion using action time. In FIG. 7, (1) indicates an example of conversion using “action time” in the case where “height to the sky” has been input as the target object and “length” has been input as the amount type. In this case, “height to the sky” is converted into a numeric value of length (i.e., distance), and is thereafter converted into the required amount of time in the case where a human walks that distance. In this case, in the example shown in FIG. 7, “96 minutes on foot” has been set as the conversion result.

Also, (2) indicates an example of conversion using “action time” in the case where “height to the ceiling of the Sagrada Familia” has been input as the target object name and “length” has been input as the amount type. In this case, the “height to the ceiling of the Sagrada Familia” is converted into a numeric value of height (i.e., distance), and is thereafter converted into the required amount of time in the case where a human walks that distance. As a result, in the example shown in FIG. 7, “30 seconds on foot” has been set as the conversion result. Note that the amount type of the numeric values that can be converted into the action time is limited to length (also includes size). It is desirable that numeric values of other amount types, such as weight and density, are converted using another conversion method.

“Perspective conversion” refers to a conversion method of expressing what object would be equivalent to a human if a numeric value (target object) was replaced with a human (what object from a human perspective would be equivalent to a human from the perspective of the numeric value (target object)).

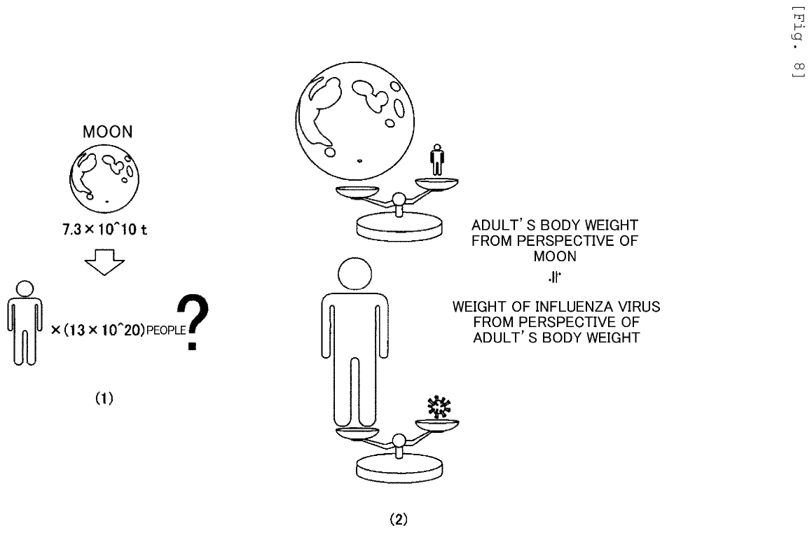

FIG. 8 is a diagram showing an example of conversion using perspective conversion in the case where a numeric value of weight (target object) is difficult to convey due to being too large. FIG. 8 shows an example of conversion of a numeric value (7.3×10¹⁰ t) indicating the weight of the moon.

(1) shows an example in which such a large numeric value is expressed using “multiple” (multiple of a body part of a human). In this case, the average body weight of an adult×13×10²⁰ is the conversion result, but this conversion result is difficult to understand.

(2) shows an example in which the numeric value has been converted using “perspective conversion”. In this case, as shown on the upper side of (2), the object that would be equivalent to the average body weight of an adult if the weight of the moon was replaced with the average body weight of an adult is obtained. In the example shown in (2), in this case, it is indicated that the average body weight of an adult would be equivalent to the weight of an influenza virus. That is, in (2), the weight of the moon is expressed using the fact that the average body weight of an adult would be equivalent to the weight of an influenza virus if the moon were the average body weight of an adult. In other words, it is expressed that an adult's body weight from the perspective of the moon is equivalent to the weight of an influenza virus from the perspective of an adult's body weight.

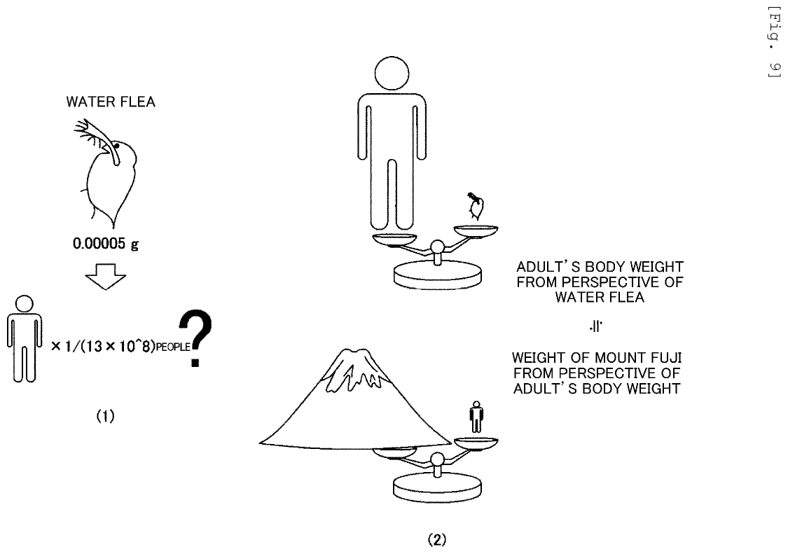

FIG. 9 is a diagram showing an example of conversion using perspective conversion in the case where a numeric value of weight (target object) is difficult to convey due to being too small. FIG. 9 shows a conversion example in which the target object is a numeric value (0.00005 g), which indicates the weight of a water flea.

(1) shows an example in which such a small numeric value is expressed using “multiple” (multiple of a body part of a human). In this case, the average body weight of an adult/(13×10⁸) is the conversion result, but this conversion result is difficult to understand.

(2) shows an example in which the numeric value has been converted using “perspective conversion”. In this case, as shown on the upper side of (2), the object that would be equivalent to the average body weight of an adult if the weight of a water flea were replaced with the average body weight of an adult is obtained. In the example shown in (2), in this case, it is indicated that the average body weight of an adult would be equivalent to the weight of Mount Fuji. That is, in (2), the weight of a water flea is expressed using the fact that the average body weight of an adult would be equivalent to the weight of Mount Fuji if a water flea was the average body weight of an adult. In other words, it is expressed that an adult's body weight from the perspective of a water flea is equivalent to the weight of Mount Fuji from the perspective of an adult's body weight.

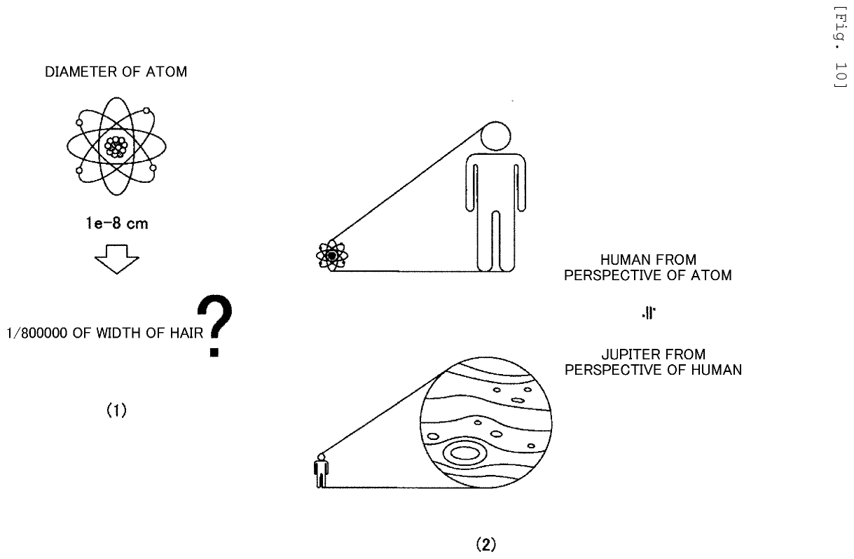

FIG. 10 is a diagram showing an example of conversion using perspective conversion in the case where a numeric value (target object) of length is difficult to convey due to being too small. FIG. 10 shows a conversion example in which the target object is a numeric value (le-8 cm), which indicates the diameter of an atom.

(1) shows an example in which such a small numeric value is expressed using “multiple” (multiple of a human body part). In this case, 1/800000 of the width of a hair is the conversion result, but this conversion result is difficult to understand.

(2) shows an example in which the numeric value has been converted using “perspective conversion”. In this case, as shown on the upper side of (2), the object that would be equivalent to the average body length of an adult if the diameter of an atom were replaced with the average body length of an adult is obtained. In the example shown in (2), in this case, it is indicated that the average body length of an adult would be equivalent to the diameter of Jupiter. That is, in (2), the diameter of an atom is expressed using the fact that the average body length of an adult would be equivalent to the diameter of Jupiter if the diameter of an atom was the average body length of an adult. In other words, it is expressed that the average body length of an adult from the perspective of the diameter of an atom corresponds to the diameter of Jupiter from the perspective of the average body length of an adult.

“Projection” is a method of expressing a contrast relationship between a numeric value (target object) and another known object using a contrasting relationship between two body parts of a human.

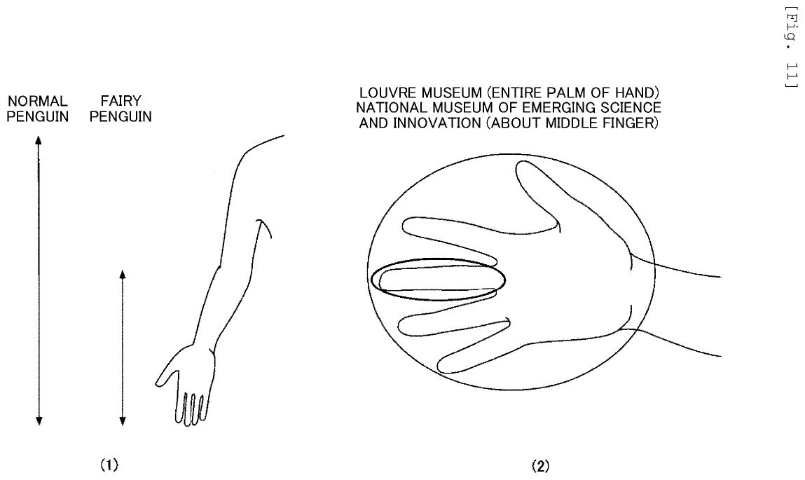

FIG. 11 is a diagram showing an example of conversion using projection. (1) in FIG. 11 shows an example in which the numeric value (target object) is the body length of a fairy penguin. In this case, the body length of a fairy penguin is expressed using a description that, based on the premise that the body length of a normal penguin is known, when the length of a human arm is taken as that of a normal penguin, the body length of a fairy penguin corresponds to the length up to the elbow of a human. Note that this does not mean that the body length of a normal penguin equals the length of a human arm and the body length of a fairy penguin equals the length up to the elbow of a human. It means that the contrast relationship between the body length of a normal penguin and the body length of a fairy penguin is expressed using the contrast relationship between the length of a human arm and the length up to an elbow of a human.

(2) shows an example in which the numeric value (target object) is the area of the Louvre Museum. In this case, the area of the Louvre Museum is expressed using the description that, based on the premise that the area of the National Museum of Emerging Science and Innovation is known, if the area of the National Museum of Emerging Science and Innovation is taken as that of a middle finger, the area of the Louvre Museum would be equivalent to that of a palm of a hand.

For example, if a value is excessively large, such as the size of the sun, or excessively small, and it is difficult to give an expression that is easy to understand using “multiple” and “human measure”, in which human body parts are used as a reference, “multiple”, in which a common object is used as a reference, is suitable. For example, in the case of the diameter of the sun, an expression with a high degree of recognition is obtained using a multiple of a numeric value of a known common object such as the earth, as in “109 times the diameter of the earth” or the like.

Note that regarding “multiples” obtained using human body parts as a reference and “multiples” obtained using common objects as a reference, the values set in the “conversion method” of the conversion reference DB 122 (FIG. 6) are all “multiples” and are used in common. However, in the case of “multiples” obtained using human body parts as a reference, the value of the “reference DB” of the conversion reference DB 122 (FIG. 6) is “human information DB”, and in the case of “multiple” obtained using common objects, the value of the “reference DB” of the conversion reference DB 122 (FIG. 6) is “general reference DB”, whereby both are automatically distinguished from each other.

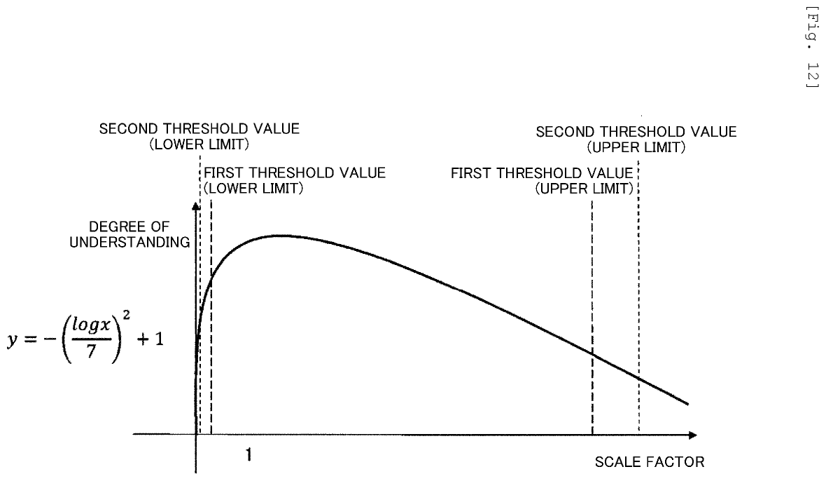

Note that FIG. 12 is a diagram for illustrating an example of a reference for determining whether or not “multiple” is to be used as the “conversion method”. In the graph shown in FIG. 12, the horizontal axis corresponds to a scale factor expressing how many times the body weight of a human, and the vertical axis corresponds to a degree of understanding indicating whether or not a person can imagine and understand the scale factor when it is shown. Based on the idea that one times the body weight of a human is the easiest to understand, the graph of FIG. 12 expresses a function in which the degree of understanding is the greatest at a scale factor of 1, and the degree of understanding decreases as the scale factor becomes less than 1 and as the scale factor becomes greater than 1 (i.e., as the scale factor moves away from 1). That is, in FIG. 12, the fact that imagining becomes more difficult (understanding becomes more difficult) if the scale factor is too small and/or if the scale factor is too large is expressed as a graph. This relationship (function expressed by the graph) may also be formulated as in the formula below, and it is also possible to determine whether or not the “conversion method” is to be “multiple” by providing a threshold value.

$$y = - {( \frac{log x}{7} )}^{2} + 1 \qquad [ Math 1 ]$$

In this case, in the threshold value setting method, with respect to values of a reference human (in FIG. 12, a body weight of one human is at a scale factor equal to 1 on the horizontal axis), a first threshold value (lower limit) or a first threshold value (upper limit) are set as values that serve as limits for being able to feel or limits for being able to view (lower limits and upper limits), such as, in the case of weight, a weight of 1 ton or more or a weight of 1 gram or less, and in the case of height, the height of Mount Fuji or more, or the thickness of a thread or less, and if a value falls outside of the range of the first threshold value, “human measure” may be used instead of conversion through “multiple”. In other words, conversion through “multiple” need only be used when a value falls within the range of the first threshold value. Furthermore, if the limit of an expression is reached even if “perspective conversion” is performed, for example, the limits (lower limit and upper limit) of the scale factor at which “perspective conversion” can only be performed for target objects that cannot be distinguished by a person, such as the size of an influenza virus or flower pollen, may be set as a second threshold value (lower limit) or a second threshold value (upper limit) outside of the range of the first threshold value, and if the value falls outside of the range of the second threshold value “multiple” obtained with reference to a common object may be performed. A method of using a questionnaire or the like to perform user evaluation or the like regarding the size of a value up to which imagining is possible is also conceivable as a method for more strictly performing the threshold value setting method.

In the above-described step S104, the conversion method determination unit 11 specifies a record (hereinafter referred to as “target record”) that corresponds to the target amount type and includes a “range” to which the input value belongs in the conversion reference DB 122, and outputs the input value and the value of the “number” (hereinafter referred to as “target number”) of the target record to the conversion processing unit 12. Note that if the target amount type and the input value are “weight, 160 kg”, the target number is “003”.

Next, the conversion processing unit 12 uses the input value and the target number output from the conversion method determination unit 11 as inputs, refers to the conversion method DB 123, and executes steps S105 and S106, and thereby executes conversion processing corresponding to the conversion method (hereinafter referred to as “target conversion method”) of the record (target record) of the target number on the input value.

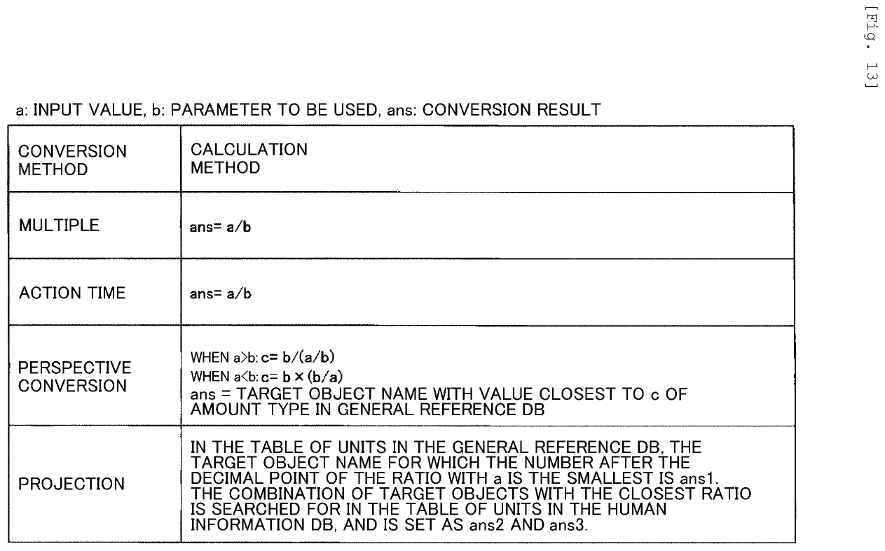

FIG. 13 is a diagram showing an example of a configuration of the conversion method DB 123. As shown in FIG. 13, in the conversion method DB 123, the specific calculation method of each conversion method included in the conversion reference DB 122 is stored in the table of the conversion method DB 123. In the calculation method, a indicates the input value, b indicates the parameter to be used, and ans indicates the conversion result.

The conversion processing unit 12 can acquire b by referring to the human information DB 124 or the general reference DB 125 based on the input value and the target number input from the conversion method determination unit 11.

Note that in the “calculation method” for “projection”, b (parameter) is not needed. Accordingly, in the conversion reference DB 122 (FIG. 6), for a record in which the “conversion method” is projection, neither “parameter to be used” nor “reference DB” are needed, and therefore it is sufficient that null or the like is set therefor.

In step S105, the conversion processing unit 12 acquires the parameter designated in “parameter to be used” of the target record corresponding to the target number from the database designated in “reference DB” of the target record. If “003” has been input as the target number from the conversion method determination unit 11, the conversion processing unit 12 refers to “parameter to be used” of the record for which the “number” is “003” in the conversion reference DB 122, and specifies that “average body weight, adult” is the parameter to be used and the human information DB 124 is the reference destination (“reference DB”). In view of this, the conversion processing unit 12 reads out the value corresponding to “average body weight, adult” from the human information DB 124.

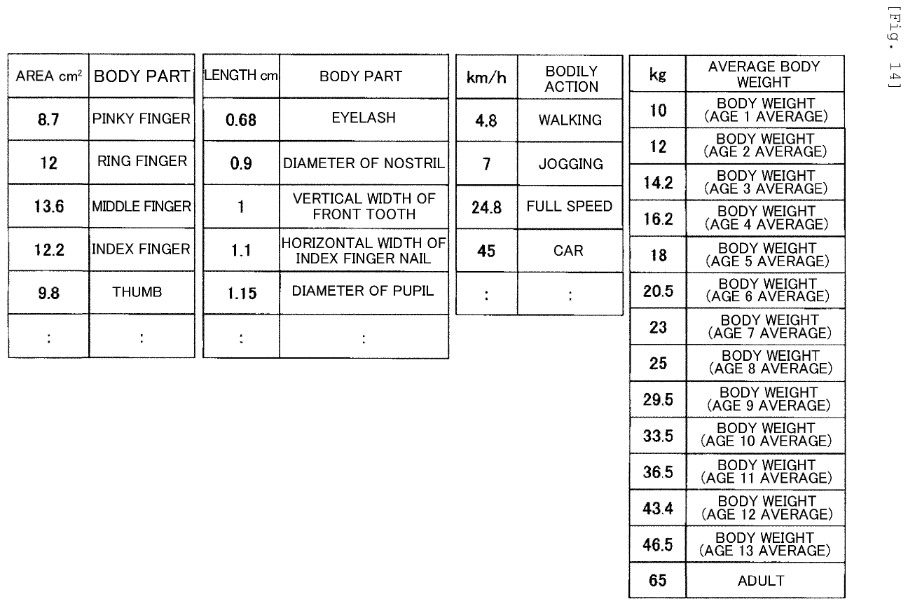

FIG. 14 is a diagram showing an example of a configuration of the human information DB 124. As shown in FIG. 14, multiple tables including average measurement values of human body parts, average values of the speed of bodily actions, and the like are stored in the human information DB 124. These tables are created for each amount type.

Furthermore, the tables may also be created for each attribute, such as country, sex, and age. The amount types used in the human information DB 124 match the amount types included in the amount information DB 121.

For example, the value corresponding to “average body weight, adult” is read out as “65”.

Note that the human information DB 124 may also be created by referring to, for example, the following citation sources and the like.
“Human Feature Measurement Database (National Institute of Technology and Evaluation) http://www.tech.nite.go.jp/human/Application/search/Search.php”
“Morphologic Study of the Finger Nail, Distal Portion of the Digit, and Distal Phalanx https:///www.jstage.jst.go.jp/article/jsma1939/56/2/56_2_175/pdf (nail and fingertip data)”
“School Health Statistics Survey https://www.e-stat.go.jp/dbview?sid=0003147022 (body length and body weight by age)”

Note that if the “reference DB” of the target record corresponding to the target number is “general reference DB 125”, the conversion processing unit 12 acquires parameters from the general reference DB 125.

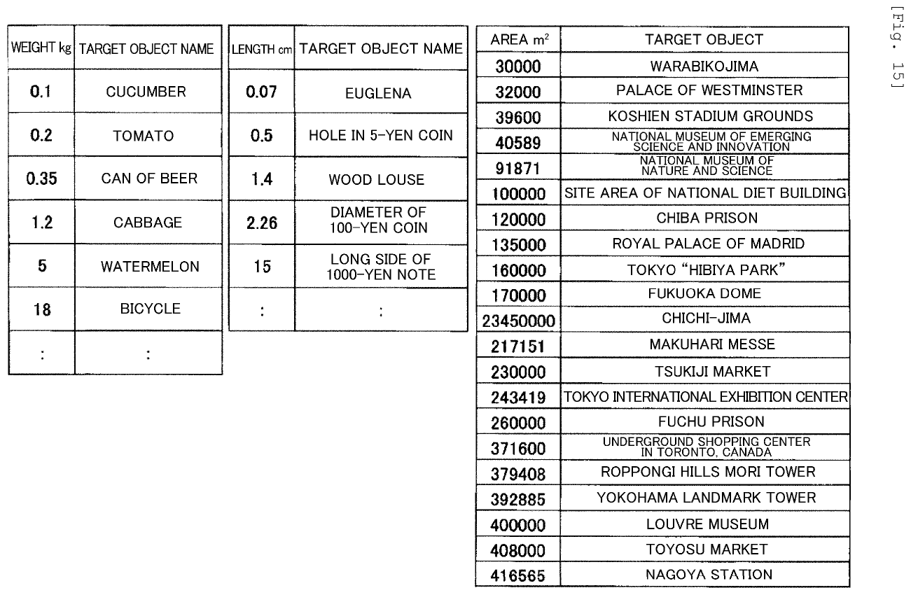

FIG. 15 is a diagram showing an example of a configuration of the general reference DB 125. As shown in FIG. 15, for each amount type, regarding common target objects with a high degree of recognition, values of the amount type relating to the target objects are stored in advance in the general reference DB. The amount types used in the general reference DB 125 match the amount types included in the amount information DB 121. For example, common target objects are created using methods such as a service provider manually creating target objects that it is determined that anyone can imagine, collecting and including target objects are used in descriptions, such as “about the length of oo” on Q&A sites, and performing user evaluation of a list of target objects and their amount types, evaluating the degree of recognition, and including target objects that 80% of people or more can recognize. Also, an additional function such as causing selection of a genre in step S101, creating a general reference DB 125 for each genre as well, and thereby outputting target objects of the same genre, such as outputting food in response to food or outputting an animal in response to an animal, may also be added.

Next, the conversion processing unit 12 executes conversion by applying the input value to a and applying the acquired parameter to b of the “calculation method” associated with the target conversion method in the conversion method DB 123 (FIG. 13) (S106). ans is calculated by conversion. For example, if the input value a=160, the parameter b=65, and the conversion method=“multiple”, according to the “calculation method” of the conversion method DB 123 (FIG. 13), the conversion is realized through the following computation.

ans=160/65≈2.5

In this case, the conversion processing unit 12 outputs the value of ans and the target number, that is, ans=2.5 and column number 003, to the display formatting unit 13. Note that regarding the number of digits in the calculation processing, for example, a setting such as rounding the second decimal may also be performed in advance. This setting may also be changed for each conversion method. Also, if the units of a and b need to match during calculation (in the present embodiment, all conversion methods except “projection”), that is, if the units of a and b are different, for example, the conversion processing unit 12 refers to the table T2 of the amount information DB 121 and performs calculation after performing conversion such that the value of b matches the unit of a.

Next, using the value of ans and the target number as inputs, the display formatting unit 13 refers to the presented expression DB 126, generates an output sentence for expressing the input value (S107), and outputs the output sentence.

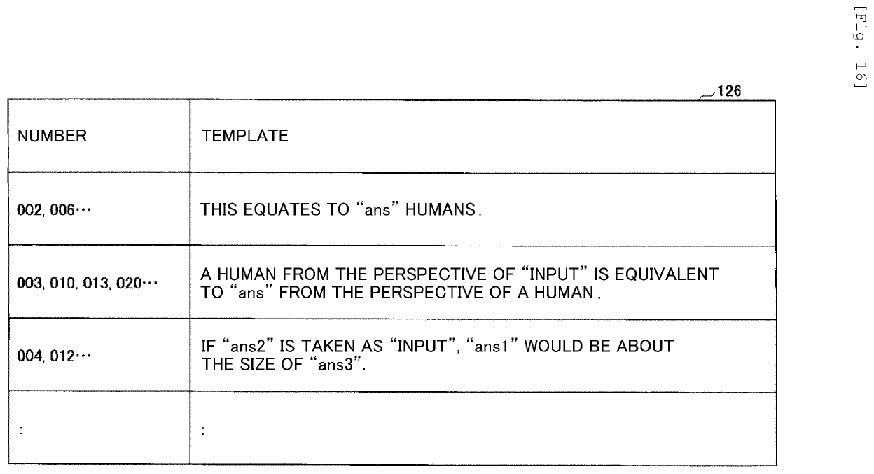

FIG. 16 is a diagram showing an example of a configuration of the presented expression DB 126. As shown in FIG. 16, in the presented expression DB 126, templates for text (output sentences) that is ultimately output are included for the numbers of all of the records included in the conversion reference DB 122. The templates are created and registered in advance in a format in which ans and the like that are calculated in step S107 are inserted therein.

Accordingly, the display formatting unit 13 generates the output sentence by specifying the record including the target number in “number” in the presented expression DB 126 and inserts the value of ans that was input into the template of the record. For example, according to the above-described example, the output sentence “This equates to 2.5 humans” is generated.

Next, using the output sentence generated by the display formatting unit 13 as input, the output unit expresses the content of the output sentence as-is or through a different expression as output content, and outputs the output sentence (S108). For example, the output sentence may be displayed on the display apparatus 106, or may be output using another method. Also, the output content need not be a sentence. For example, as shown in FIGS. 8 to 11, the output content may also be expressed using a drawing or the like. In this case, it is sufficient to generate a template formed by a drawing or the like.

Next, a conversion method other than “multiple” will be described. According to FIG. 13, the method for calculating ans in the case where the conversion method is “action time” is as follows.

ans=a/b

In the case of the example shown in FIG. 7, the conversion processing unit 12 calculates ans by substituting “height to a cloud” or “height to the ceiling of the Sagrada Familia” for a and substituting the walking speed of a human for b. Note that in this case, it is assumed that “walking” is set as the “parameter to be used” in the conversion method, and “human information DB” is set as the “reference DB”.

Also, according to FIG. 13, the method for calculating ans in the case where the conversion method is “perspective conversion” is as follows.

When a>b: c=b/(a/b)
When a<b: c=b×(b/a)
ans=the target object name of the value closest to c of the amount type in the general reference DB 125.

For example, in the case of FIG. 8(2), the conversion processing unit 12 substitutes the weight of the moon for a and uses the average body weight of an adult as b. In this case, since a>b, the conversion processing unit 12 executes calculation of c=b/(a/b)

On the other hand, in the case of FIG. 8(2), the conversion processing unit 12 substitutes the weight of a water flea for a and uses the average body weight of an adult as b. In this case, since a<b, the conversion processing unit 12 executes calculation of c=b×(b/a).

The conversion processing unit 12 substitutes the target object name corresponding to the weight that is the closest to c in the table corresponding to weight in the general reference DB 125 for ans. That is, in this case, a character string is substituted for ans.

Note that the second record in the presented expression DB 126 of FIG. 16 is the template corresponding to “perspective change”. The template includes the description “input”. If a numeric value has been input as input information, the display formatting unit 13 applies the numeric value to “input”, and if a target name has been input as input information, the display formatting unit 13 applies the target object name to “input”. The same also applies to the third record.

Furthermore, according to FIG. 13, the method for calculating ans in the case where the conversion method is “projection” is as follows.

“In the table of units in the general reference DB 125, the target object name for which the number after the decimal point of the ratio with a is the smallest is ans1. The combination of target objects with the closest ratio is searched for in the table of units in the human information DB 124, and is set as ans2 and ans3.”
For example, in the case of FIG. 11(2), a, which is the input value, indicates the area of the Louvre Museum. In view of this, the conversion processing unit 12 refers to the table of areas of the general reference DB 125 and substitutes the target object name of the area for which the number after the decimal point of the ratio with a is the smallest (that is, the area that is the closest to an integer) for ans1. Note that in this case, a target object name with a ratio that is a good cutoff, such as a factor of 2, a factor of 5, or a factor of 10, may also be selected with priority. Note that the ratio between the area of the selected target name and a will be referred to hereinafter as “target proportion”.

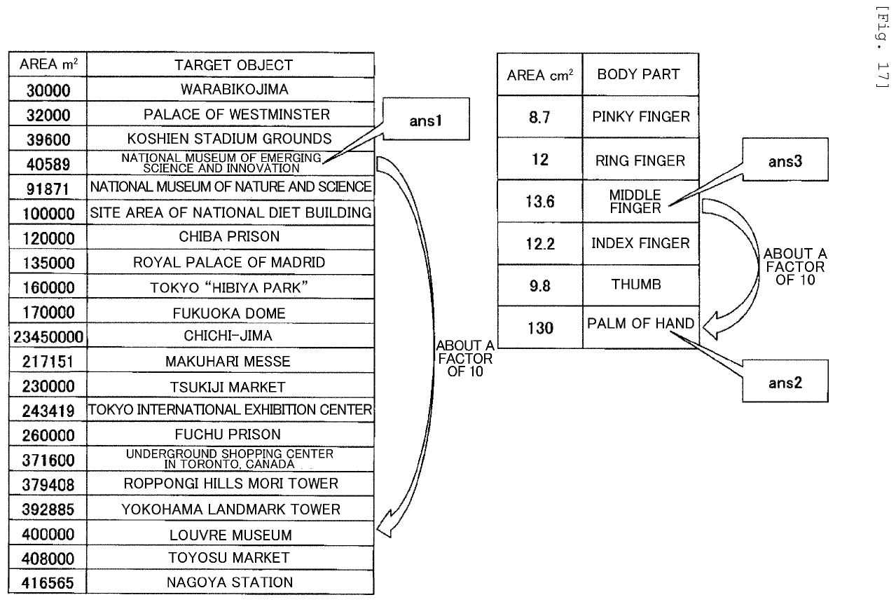

Hereinafter, description will be given with reference to FIG. 17. FIG. 17 is a diagram for illustrating conversion processing for projection. In FIG. 17, for the sake of convenience, it is assumed that “National Museum of Emerging Science and Innovation” has been substituted for ans1.

In this case, the conversion processing unit 12 searches for the combination of two body parts whose areal ratio is the closest to the target ratio among the body parts registered in the table of areas of the human information DB 124 (FIG. 14). In the example shown in FIG. 17, the ratio (scale factor) of a (the area of the Louvre Museum) with respect to the area of ans1 (the National Museum of Emerging Science and Innovation) is about a factor of 10. In view of this, the conversion processing unit 12 searches for the combination of body parts whose areal ratio is about a factor of 10 among the body parts registered in the table of areas of the human information DB 124 (FIG. 14). In the example shown in FIG. 17, it is shown that the area of a palm of a hand is about 10 times the area of a middle finger. In this case, the conversion processing unit 12 substitutes the palm of a hand for ans2 and substitutes a middle finger for ans3.

Note that the third record in the presented expression DB 126 of FIG. 16 is the template corresponding to “projection”. Thus, according to the example shown in FIG. 17, based on the template, the display formatting unit 13 generates the output sentence “If the palm of a hand is taken as the Louvre Museum, the National Museum of Emerging Science and Innovation would be about the size of a middle finger.”.

Note that there are many combinations of two body parts, and there are body parts that are easy to understand (or easy to recognize) and body parts that are difficult to understand (or difficult to recognize) when used in a comparison (ratio). For example, if areas are expressed using the size of hands and feet, or the size of hands and feet and the size of an eye, or the like when projecting the areas onto body parts, visual observation is possible and it is easy to understand, but if they are expressed using the sizes of eyelashes and eyebrow hairs, or the like, checking in a mirror or the like will be necessary, which is troublesome, and it will be difficult to understand. In view of this, priority levels in a range of 0 to 1 are set for body parts and bodily actions in each table to the human information DB 124, and when a combination to be used in the contrasting of a and ans1 is selected, weighting may also be performed using the priority levels. For example, a combination for which the total value of the priority levels is the greatest among combinations for which the difference from a target ratio is a threshold value or less may also be selected. Note that here, it is assumed that the greater the priority level is, the higher the priority is. Note that the priority level for each body part may also be set based on whether or not the body part is easily viewable, or the like.

As described above, according to the present embodiment, a conversion method according to the input amount type and size of the numeric value is used to convert the numeric value into a relative value obtained based on a predetermined reference (“multiple”, “action time”, “perspective conversion”, “projection”), and that value is applied to a template and output. As a result, it is possible to generate an easily understandable expression for the value.

For example, according to the present embodiment, a numeric value that is extremely small or large, or a numeric value of an amount value that is not familiar is expressed by being replaced with a measurement anyone can easily imagine, such as observed values of body parts and bodily actions of a human, whereby it is possible to make it easier to more specifically understand the degree of a numeric value or the like that could only be vaguely understood. This makes it possible to promote comprehension of the sense of degree of a phenomenon that there is little opportunity to check in person, such as a numeric expression that appears in an article in an unfamiliar field on Web news or the like, the weight of armor, or the height of buildings overseas, and thus it is possible to expect promotion of understanding of foreign cultures, use in descriptive support in sightseeing guides, and the like. Also, during shopping on an EC site or the like, by converting weights and sizes of objects that cannot be physically checked into expressions using body parts, it is also possible to easily convey the actual size values without using a ruler or a tape measure.

Note that in the present embodiment, the conversion method determination unit 11 is an example of a determination unit. The conversion processing unit 12 is an example of a conversion unit. The display formatting unit 13 is an example of an output unit. “Action time” is an example of a first method. “Perspective conversion” is an example of a second method. “Projection” is an example of a third method. “Multiple” is an example of a fourth method. The range of the first threshold value in FIG. 12 is an example of a first range. The range of the second threshold value in FIG. 12 is an example of a second range.

Although an embodiment of the present invention was described in detail above, the present invention is not limited to a specific embodiment, and various modifications and changes are possible within the range of the gist of the present invention described in the claims.

### REFERENCE SIGNS LIST

10 Conversion apparatus
11 Conversion method determination unit
12 Conversion processing unit
13 Display formatting unit
100 Drive apparatus
101 Storage medium
102 Auxiliary storage apparatus
103 Memory apparatus
104 CPU
105 Interface apparatus
106 Display apparatus
107 Input apparatus
121 Amount information DB
122 Conversion reference DB
123 Conversion method DB
124 Human information DB
125 General reference DB
126 Presented expression DB
B Bus

1. A conversion apparatus comprising:
a determiner configured to, using a numeric value of an amount of a given type as input, determine a conversion method to be applied to the numeric value among a plurality of conversion methods based on the type of the amount and the size of the numeric value;
a converter configured to convert the numeric value into a relative value obtained based on a predetermined reference, using the conversion method determined by the determiner; and
an outputter configured to output a result of applying the value to a predetermined template.

2. The conversion apparatus according to claim 1, wherein the determiner determines the conversion method to be applied to the numeric value by referring to a store storing a conversion method for each range of numeric values relating to the amount.

3. The conversion apparatus according to claim 1, wherein the plurality of conversion methods include at least one or more of a first method of converting the numeric value into an action time of a human, a second method of converting the numeric value into an object that would be equivalent to a human when the numeric value was replaced with the amount of a human, and a third method of expressing a contrast relationship between the numeric value and a given object using a contrast relationship between two body parts of a human.

4. The conversion apparatus according to claim 3, wherein, when the third method has been determined by the determiner, the converter selects the two body parts based on a priority level set based on ease of recognition for each body part of a human.

5. The conversion apparatus according to claim 1, wherein the plurality of conversion methods include a fourth method of converting the numeric value into a multiple of another value, and based on a relationship in which a degree of comprehension decreases the further from 1 a scale factor of the numeric value with respect to the value of the amount for a human is, when the scale factor is within a first range from 1, the determiner determines the fourth method of converting the numeric values into the multiple of the value of the amount of a human as the conversion method to be applied to the numeric value, and, when the scale factor is outside of a second range that is outside of the first range, the determiner determines the fourth method of converting the numeric value into a multiple of the value of the amount of an object that is not a human as the conversion method to be applied to the numeric value.

6. A computer-implemented conversion method for conversion, the method comprising:
determining, by a determiner, using a numeric value of an amount of a given type as input, a conversion method to be applied to the numeric value among a plurality of conversion methods based on the type of the amount and the size of the numeric value;
converting, by a converter, the numeric value into a relative value obtained based on a predetermined reference using the conversion method determined in the determination procedure; and
outputting, by an outputter, a result of applying the value to a predetermined template.

7. A computer-readable non-transitory recording medium storing computer-executable program instructions that when executed by a processor cause a computer system to:
determining, b a determiner, using a numeric value of an amount of a given type as input, a conversion method to be applied to the numeric value among a plurality of conversion methods based on the type of the amount and the size of the numeric value;
converting, by a converter, the numeric value into a relative value obtained based on a predetermined reference using the conversion method determined in the determination procedure; and
outputting, by an outputter, a result of applying the value to a predetermined template.

8. The conversion apparatus according to claim 2, wherein the plurality of conversion methods include at least one or more of a first method of converting the numeric value into an action time of a human, a second method of converting the numeric value into an object that would be equivalent to a human when the numeric value was replaced with the amount of a human, and a third method of expressing a contrast relationship between the numeric value and a given object using a contrast relationship between two body parts of a human.

9. The conversion apparatus according to claim 2, wherein the plurality of conversion methods include a fourth method of converting the numeric value into a multiple of another value, and based on a relationship in which a degree of comprehension decreases the further from 1 a scale factor of the numeric value with respect to the value of the amount for a human is, when the scale factor is within a first range from 1, the determiner determines the fourth method of converting the numeric values into the multiple of the value of the amount of a human as the conversion method to be applied to the numeric value, and, when the scale factor is outside of a second range that is outside of the first range, the determiner determines the fourth method of converting the numeric value into a multiple of the value of the amount of an object that is not a human as the conversion method to be applied to the numeric value.

10. The computer-implemented method according to claim 6, wherein the determiner determines the conversion method to be applied to the numeric value by referring to a store storing a conversion method for each range of numeric values relating to the amount.

11. The computer-implemented method according to claim 6, wherein the plurality of conversion methods include at least one or more of a first method of converting the numeric value into an action time of a human, a second method of converting the numeric value into an object that would be equivalent to a human when the numeric value was replaced with the amount of a human, and a third method of expressing a contrast relationship between the numeric value and a given object using a contrast relationship between two body parts of a human.

12. The computer-implemented method according to claim 6, wherein the plurality of conversion methods include a fourth method of converting the numeric value into a multiple of another value, and based on a relationship in which a degree of comprehension decreases the further from 1 a scale factor of the numeric value with respect to the value of the amount for a human is, when the scale factor is within a first range from 1, the determiner determines the fourth method of converting the numeric values into the multiple of the value of the amount of a human as the conversion method to be applied to the numeric value, and, when the scale factor is outside of a second range that is outside of the first range, the determiner determines the fourth method of converting the numeric value into a multiple of the value of the amount of an object that is not a human as the conversion method to be applied to the numeric value.

13. The computer-readable non-transitory recording medium according to claim 7, wherein the determiner determines the conversion method to be applied to the numeric value by referring to a store storing a conversion method for each range of numeric values relating to the amount.

14. The computer-readable non-transitory recording medium according to claim 7, wherein the plurality of conversion methods include at least one or more of a first method of converting the numeric value into an action time of a human, a second method of converting the numeric value into an object that would be equivalent to a human when the numeric value was replaced with the amount of a human, and a third method of expressing a contrast relationship between the numeric value and a given object using a contrast relationship between two body parts of a human.

15. The computer-readable non-transitory recording medium according to claim 7, wherein the plurality of conversion methods include a fourth method of converting the numeric value into a multiple of another value, and based on a relationship in which a degree of comprehension decreases the further from 1 a scale factor of the numeric value with respect to the value of the amount for a human is, when the scale factor is within a first range from 1, the determiner determines the fourth method of converting the numeric values into the multiple of the value of the amount of a human as the conversion method to be applied to the numeric value, and, when the scale factor is outside of a second range that is outside of the first range, the determiner determines the fourth method of converting the numeric value into a multiple of the value of the amount of an object that is not a human as the conversion method to be applied to the numeric value.

16. The computer-implemented method according to claim 10, wherein the plurality of conversion methods include at least one or more of a first method of converting the numeric value into an action time of a human, a second method of converting the numeric value into an object that would be equivalent to a human when the numeric value was replaced with the amount of a human, and a third method of expressing a contrast relationship between the numeric value and a given object using a contrast relationship between two body parts of a human.

17. The computer-implemented method according to claim 10, wherein the plurality of conversion methods include a fourth method of converting the numeric value into a multiple of another value, and based on a relationship in which a degree of comprehension decreases the further from 1 a scale factor of the numeric value with respect to the value of the amount for a human is, when the scale factor is within a first range from 1, the determiner determines the fourth method of converting the numeric values into the multiple of the value of the amount of a human as the conversion method to be applied to the numeric value, and, when the scale factor is outside of a second range that is outside of the first range, the determiner determines the fourth method of converting the numeric value into a multiple of the value of the amount of an object that is not a human as the conversion method to be applied to the numeric value.

18. The computer-implemented method according to claim 11,
wherein, when the third method has been determined by the determiner, the converter selects the two body parts based on a priority level set based on ease of recognition for each body part of a human.

19. The computer-readable non-transitory recording medium according to claim 13, wherein the plurality of conversion methods include at least one or more of a first method of converting the numeric value into an action time of a human, a second method of converting the numeric value into an object that would be equivalent to a human when the numeric value was replaced with the amount of a human, and a third method of expressing a contrast relationship between the numeric value and a given object using a contrast relationship between two body parts of a human.

20. The computer-readable non-transitory recording medium according to claim 14, wherein, when the third method has been determined by the determiner, the converter selects the two body parts based on a priority level set based on ease of recognition for each body part of a human.
